(19) United States
(12) Patent Application Publication
(10) Pub. No.: US 2024/0329818 A1
(43) Pub. Date: Oct. 3, 2024

(54) DISPLAY METHOD, DISPLAY DEVICE, AND NON-TRANSITORY COMPUTER-READABLE STORAGE MEDIUM STORING PROGRAM

(71) Applicant: SEIKO EPSON CORPORATION, Tokyo (JP)

(72) Inventor: Rui ARUGA, AZUMINO-SHI (JP)

(21) Appl. No.: 18/619,812

(22) Filed: Mar. 28, 2024

(30) Foreign Application Priority Data
Mar. 30, 2023 (JP) 2023-054768

(51) Int. Cl. G06F 3/04845; G06F 3/0482; G06F 3/0487; H04N 9/31

(52) U.S. Cl. CPC G06F 3/04845; G06F 3/0482; H04N 9/3179; G06F 3/0487

(57) ABSTRACT

A projector receives, via a first selection image, an operation of determining a first combination of partial images including one of a plurality of first candidate images that are candidates for a partial image in a first region and one of a plurality of second candidate images that are candidates for a partial image in a second region, and displays a decoration image including the partial image in the first region and the partial image in the second region corresponding to the first combination and disposed along an outline of a content image.

The present application is based on, and claims priority from JP Application Serial Number 2023-054768, filed Mar. 30, 2023, the disclosure of which is hereby incorporated by reference herein in its entirety.

### BACKGROUND

### 1. Technical Field

The present disclosure relates to a display method, a display device, and a non-transitory computer-readable storage medium storing a program.

### 2. Related Art

In the related art, there is a technique of providing an image suitable for user preferences.

For example, JP-A-2013-109239 discloses an image display device that includes an image display portion and a frame located around the image display portion and is configured such that a width of the frame can be variably controlled. The frame includes a non-image display region surrounding the image display portion and a frame portion surrounding the non-image display region. The width of the frame is variably controlled by changing a width of the non-image display region.

JP-A-2013-109239 is an example of the related art.

However, in the image display device disclosed in JP-A-2013-109239, a position and shape of the frame portion cannot be changed due to a structure of the image display device. Therefore, a degree of freedom of presentation or decoration performed on an image displayed by the image display portion is not high.

### SUMMARY

According to an aspect of the present disclosure, there is provided a display method including: receiving, via first user interface image, an operation of determining a first combination of partial images including one of a plurality of first candidate images that are candidates for a first partial image and one of a plurality of second candidate images that are candidates for a second partial image; and displaying a second image including the first partial image and the second partial image corresponding to the first combination and disposed along an outline of a first image.

According to an aspect of the present disclosure, there is provided a display device including: an optical device; and at least one processor, in which the at least one processor executes operations of displaying a first user interface image by controlling the optical device, receiving, via the first user interface image, an operation of determining a first combination of partial images including one of a plurality of first candidate images that are candidates for a first partial image and one of a plurality of second candidate images that are candidates for a second partial image, and displaying, by controlling the optical device, a second image including the first partial image and the second partial image corresponding to the first combination and disposed along an outline of a first image.

According to an aspect of the present disclosure, there is provided a non-transitory computer-readable storage medium storing a program, the program causing a computer to execute operations including: receiving, via a first user interface image, an operation of determining a first combination of partial images including one of a plurality of first candidate images that are candidates for a first partial image and one of a plurality of second candidate images that are candidates for a second partial image; and displaying a second image including the first partial image and the second partial image corresponding to the first combination and disposed along an outline of a first image.

### BRIEF DESCRIPTION OF THE DRAWINGS

FIG. 1 is a block diagram showing a configuration of a projector.

FIG. 2 is a diagram showing an example of a content image.

FIG. 3 is a diagram showing an example of a decoration image.

FIG. 4 is a diagram showing an example of a composite image.

FIG. 5 is a diagram showing an example of a mode selection image.

FIG. 6 is a diagram showing an example of a first selection image.

FIG. 7 is an enlarged view of a first preset image.

FIG. 8 is a diagram showing an example of a second selection image.

FIG. 9 is a diagram showing a partial image in a first region after a change.

FIG. 10 is a diagram showing another example of the second selection image.

FIG. 11 is a diagram showing another example of the second selection image.

FIG. 12 is a diagram showing another example of the second selection image.

FIG. 13 is a flowchart showing an operation of the projector.

FIG. 14 is a diagram showing an example of a third selection image.

FIG. 15 is a diagram showing a projection image displayed on a screen.

FIG. 16 is a diagram showing a system configuration according to a third embodiment.

FIG. 17 is a diagram showing an example of a display on a touch panel.

### DESCRIPTION OF EMBODIMENTS

Hereinafter, embodiments of the present disclosure will be described with reference to the drawings.

### 1. Configuration of Projector According to First Embodiment

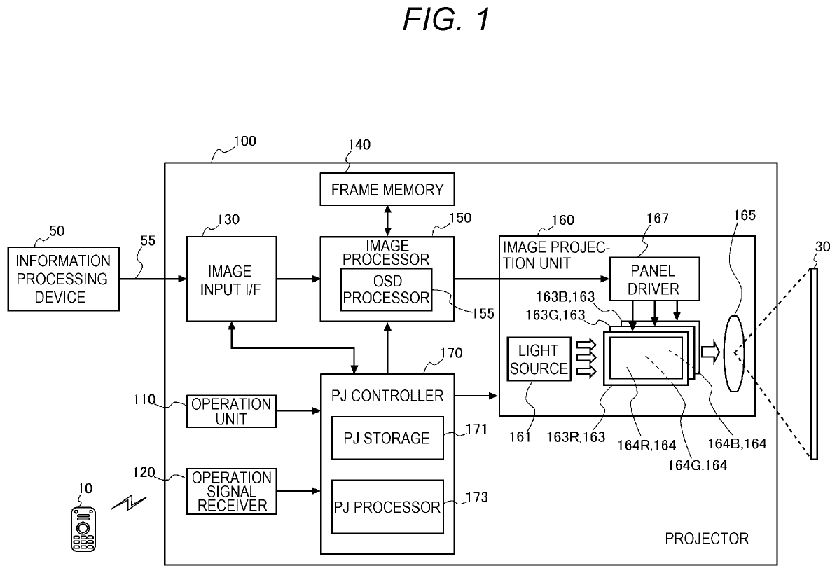

FIG. 1 is a block diagram showing a configuration of a projector 100 as a display device.

The configuration of the projector 100 will be described with reference to FIG. 1.

The projector 100 includes an operation unit 110, an operation signal receiver 120, an image input interface 130, a frame memory 140, an image processor 150, an image projection unit 160, and a PJ controller 170. Hereinafter, the interface is abbreviated as an I/F.

The operation unit 110 includes a plurality of operation keys. A user inputs various instructions to the projector 100 by operating the operation keys of the operation unit 110. When the user operates the operation key of the operation unit 110, the operation unit 110 outputs, to the PJ controller 170, an operation signal corresponding to the operated operation key. The operation keys of the operation unit 110 include a power key for switching power on and off, a menu key for displaying a menu for performing various settings, a direction key for selecting a menu item, and an enter key for determining an operation.

The operation signal receiver 120 is a receiving device for an infrared signal, and includes a light receiving element, a decoder, and the like (not shown). The operation signal receiver 120 receives and decodes an infrared signal transmitted from a remote control 10. The operation signal receiver 120 decodes the infrared signal and outputs, to the PJ controller 170, an operation signal corresponding to the operated operation key or button on the remote control 10. The operation signal receiver 120 may receive a wireless signal by Bluetooth or the like from the remote control 10. Bluetooth is a registered trademark. When a wireless signal is received, the operation signal receiver 120 may include an antenna and a reception circuit. The operation unit 110 and the operation signal receiver 120 can also be referred to as an operation input I/F.

The remote control 10 includes a plurality of operation keys similar to those of the operation unit 110. For example, the remote control 10 includes a menu key for displaying a menu for performing various settings, direction keys corresponding to four directions, upper, lower, left, and right, for selecting a menu item, and an enter key for determining an operation. The remote control 10 also includes a combination button for instructing a combination of the decoration image 300 or for instructing cancellation of a combination. When the combination button is turned on, the projector 100 combines the decoration image 300 with an input image supplied from an information processing device 50 to generate a composite image 400, and displays the generated composite image 400 on a screen 30. When the combination button is turned off, the projector 100 displays an input image supplied from the information processing device 50 on the screen 30. The remote control 10 may be a mobile terminal such as a smartphone. In this case, an I/F image of the operation key is displayed on a touch panel of the mobile terminal by application software installed in the mobile terminal.

An image input I/F 130 includes a connector and an interface circuit, and is wired to the information processing device 50 via a cable 55. The information processing device 50 is an external device that supplies an image signal to the projector 100, and for example, a desktop personal computer, a notebook personal computer, a tablet personal computer, or a smartphone is used. The image input I/F 130 extracts an input image in the image signal received via the cable 55, and outputs the extracted input image to the image processor 150. As the image input I/F 130, for example, a high-definition multimedia interface (HDMI) is used. HDMI is a registered trademark. In the embodiment, a case will be described in which a coupling form between the information processing device 50 and the projector 100 is wired, but the coupling form between the information processing device 50 and the projector 100 may be wireless.

The frame memory 140 is coupled to the image processor 150. The image processor 150 includes an on screen display (OSD) processor 155.

The image processor 150 loads the input image input from the information processing device 50 into the frame memory 140.

The OSD processor 155 superimposes an OSD image on the input image loaded into the frame memory 140 under control of the PJ controller 170. The OSD processor 155 includes an OSD memory (not shown). The OSD memory stores OSD image information representing figures, fonts, and the like for forming the OSD image. When the OSD processor 155 is instructed by the PJ controller 170 to superimpose an OSD image, the OSD processor 155 reads necessary OSD image information from the OSD memory and superimposes the OSD image on an input image loaded into the frame memory 140.

The image processor 150 performs, for example, an image process on the image loaded into the frame memory 140, such as a resolution conversion process, a resizing process, distortion aberration correction, a shape correction process, a digital zoom process, and adjustment of hue or luminance of the image. The image loaded into the frame memory 140 is an input image or an image in which an OSD image is superimposed on the input image.

The image processor 150 outputs image information, which is information on the image loaded into the frame memory 140, to a panel driver 167 of the image projection unit 160.

The frame memory 140 and the image processor 150 are implemented with an integrated circuit, for example. The integrated circuit includes a large scale integrated circuit (LSI), an application specific integrated circuit (ASIC), a programmable logic device (PLD), a field-programmable gate array (FPGA), a system-on-a-chip (SoC), and the like. The frame memory 140 and the image processor 150 may include an analog circuit as a part of a configuration of the integrated circuit, or may have a configuration in which the PJ controller 170 and the integrated circuit are combined.

The image projection unit 160 includes a light source 161, three liquid crystal panels 163R, 163G, and 163B as a light modulation device, a projection lens 165 as an optical system unit, and the panel driver 167. Hereinafter, the liquid crystal panels 163R, 163G, and 163B are collectively referred to as a liquid crystal panel 163. The liquid crystal panel 163 corresponds to a display panel. The light source 161, the liquid crystal panels 163R, 163G, and 163B, and the projection lens 165 in the image projection unit 160 correspond to an optical device.

The light source 161 includes a solid-state light source such as a light-emitting diode or a semiconductor laser. As the light source 161, a discharge type light source lamp such as an ultra-high pressure mercury lamp or a metal halide lamp may be used. A light emitted from the light source 161 according to an instruction from the PJ controller 170 is converted into a light having a substantially uniform luminance distribution by an integrator optical system (not shown), and is separated into color light components of red (R), green (G), and blue (B) that are three primary colors of lights by a color separation optical system (not shown). Thereafter, the light separated into the color light components of red (R), green (G), and blue (B) is respectively incident on the liquid crystal panels 163R, 163G, and 163B. The light separated into the color light components incident on the liquid crystal panels 163R, 163G, and 163B is referred to as a color light.

Each of the liquid crystal panels 163R, 163G, and 163B is implemented with a transmissive liquid crystal panel in which liquid crystal is sealed between a pair of transparent substrates. In each liquid crystal panel 163, rectangular image forming regions 164R, 164G, and 164B including a plurality of pixels arranged in a matrix are formed, and a drive voltage can be applied to each pixel.

The panel driver 167 forms images in the image forming regions 164R, 164G, and 164B of the liquid crystal panels 163R, 163G, and 163B. Specifically, in accordance with an instruction from the PJ controller 170, the panel driver 167 applies a drive voltage corresponding to image information input from the image processor 150 to each pixel of the image forming regions 164R, 164G, and 164B, and sets each pixel to light transmittance corresponding to the image information. A light emitted from the light source 161 is transmitted through the image forming regions 164R, 164G, and 164B of the liquid crystal panels 163R, 163G, and 163B to be modulated for each pixel, and an image light corresponding to the image information is formed for each color light. The formed image lights with each color are combined for each pixel by a color composition optical system (not shown) to become an image light representing a color image, and are enlarged and projected on the screen 30 which is a projection surface by the projection lens 165. In the embodiment, a case where the projection surface is the screen 30 is shown, but it is also possible to use an indoor wall surface, a ceiling, an outdoor outer wall, or the like as the projection surface.

The PJ controller 170 includes a PJ storage 171 and a PJ processor 173.

The PJ storage 171 includes a volatile storage device and a nonvolatile storage device.

The volatile storage device includes, for example, a random access memory (RAM). The nonvolatile storage device is implemented with, for example, a read only memory (ROM), a flash memory, and an electrically erasable programmable read-only memory (EEPROM).

The volatile storage device is used as a calculation area for the PJ processor 173.

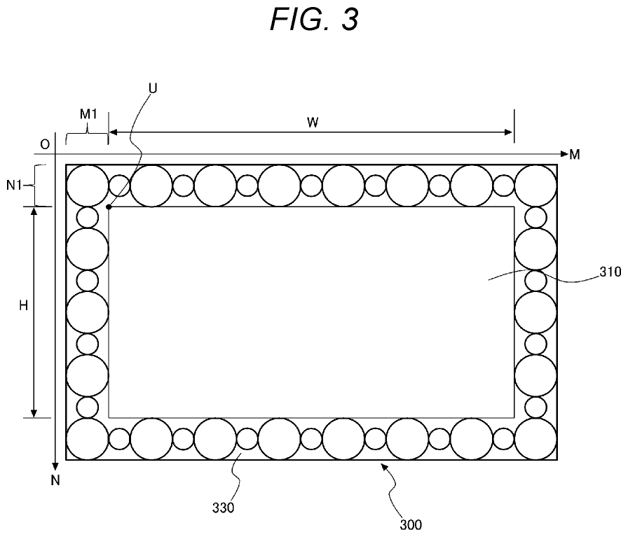

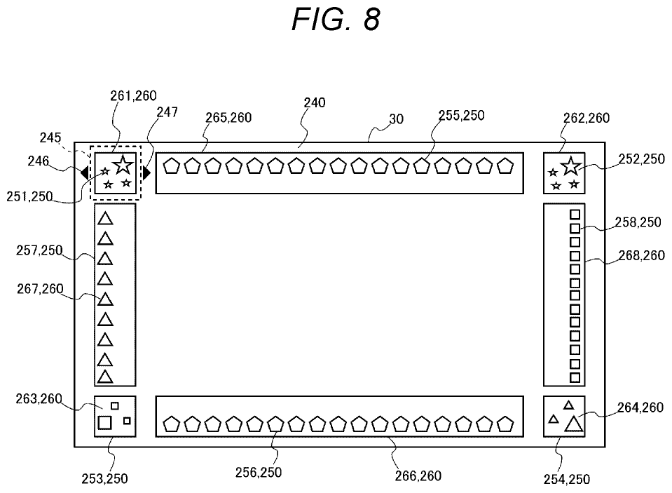

The nonvolatile storage device stores a control program executed by the PJ processor 173, a plurality of decoration images 300, partial images 250, and disposition information. Details of the decoration image 300 and the disposition information will be described later with reference to FIG. 3. The partial image 250 is a part image obtained by dividing the decoration image 300 into a plurality of parts. In other words, the decoration image 300 is divided into a plurality of regions, and the partial image 250 is an image of each portion of the decoration image 300 divided into a plurality of regions. The decoration image 300 is generated by combining the partial images 250. The PJ storage 171 stores the partial image 250 for each of the plurality of decoration images 300. The partial image 250 will be described with reference to FIG. 8.

The PJ processor 173 is an arithmetic processing device including a processor such as a central processing unit (CPU) or a micro-processing unit (MPU). The PJ processor 173 may be implemented with a single processor, or may be implemented with a plurality of processors. The PJ processor 173 may be implemented with an SoC integrated with part or all of the PJ storage 171 or other circuits. The PJ processor 173 may be implemented with a combination of a CPU that executes a program and a digital signal processor (DSP) that executes a predetermined arithmetic process. Further, all functions of the PJ processor 173 may be implemented in hardware, or a programmable device may be used.

### 2. Display of Composite Image by Projector According to First Embodiment

In the following description, the projector 100 projecting an image light onto the screen 30 to form an image on the screen 30 is referred to as a display. The image displayed on the screen 30 by the projector 100 is referred to as a projection image. An input image in an image signal received by the projector 100 from the information processing device 50 is referred to as a content image 200. In the following description, a case where the user operates the remote control 10 to cause the projector 100 to execute a process will be described, but a similar process can be executed by the projector 100 by operating the operation unit 110. The content image 200 corresponds to a first image.

The projector 100 generates the composite image 400 by combining the decoration image 300 with the content image 200 in the image signal received from the information processing device 50. The projector 100 displays, on the screen 30, an image light based on the generated composite image 400. The decoration image 300 corresponds to a second image.

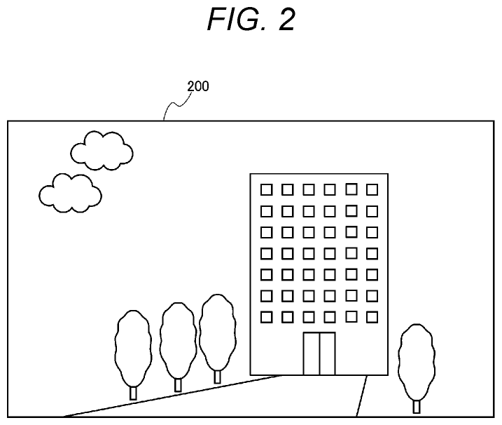

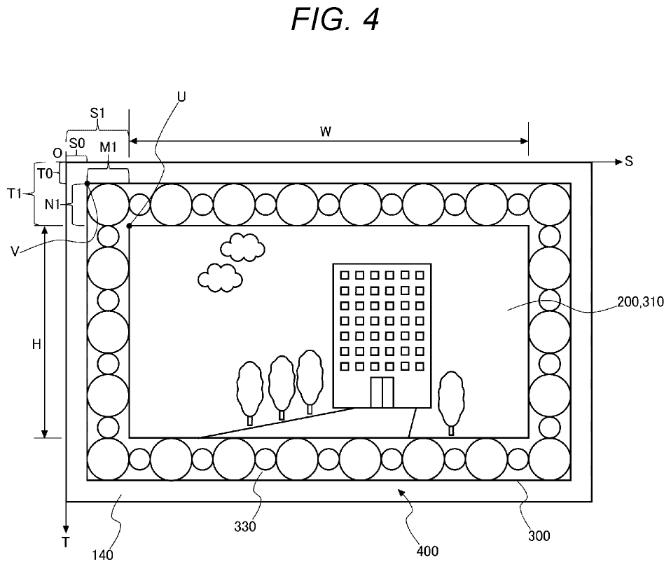

FIG. 2 is a diagram showing an example of the content image 200. FIG. 3 is a diagram showing an example of the decoration image 300. FIG. 4 is a diagram showing an example of the composite image 400.

The content image 200 is an image in the image signal supplied from the information processing device 50 to the projector 100 as described above, and may be a moving image or a still image.

In the description for FIGS. 2 to 4, a case where the decoration image 300 is combined with the content image 200 to generate the composite image 400 will be described. An operation of selecting the partial image 250 to be disposed in the decoration image 300 by an operation of the user will be described later.

The decoration image 300 is, for example, an image stored in advance in the PJ storage 171 of the projector 100, and can be combined with various content images 200. The decoration image 300 may be stored in the PJ storage 171 as a so-called template. The projector 100 may store a plurality of decoration images 300 in the PJ storage 171. The projector 100 may download the decoration image 300 from a server device (not shown), for example. The projector 100 may be configured to read, from an external storage device, the decoration image 300 stored in the storage device such as a universal serial bus (USB) memory or an SD card and use the decoration image 300.

The decoration image 300 is, for example, a rectangular image, and includes a disposition portion 310 and a frame 330.

The disposition portion 310 is located at a center of the decoration image 300, and the frame 330 is disposed along an outline of the disposition portion 310 over an entire periphery of the disposition portion 310. The disposition portion 310 is a region in which the content image 200 is disposed when the composite image 400 is generated. The image processor 150 superimposes the content image 200 on the disposition portion 310 of the decoration image 300 loaded into the frame memory 140. At this time, the frame 330 is disposed along an outline of the content image 200 outside the content image 200.

The frame 330 is a region in which a decoration image for decorating the content image 200 disposed in the disposition portion 310 is formed. An image formed at the frame 330 is different for each of a plurality of decoration images 300. That is, the plurality of decoration images 300 have different appearances.

FIG. 3 shows an example of the decoration image 300 in which the frame 330 is formed around an entire periphery of the decoration image 300, but the frame 330 may be formed at any one side, two sides, or three sides of upper and lower sides, left and right sides, and the upper, lower, left, and right sides of the rectangular decoration image 300.

The disposition information is information indicating a position and a range in which the content image 200 is disposed inside the decoration image 300. The disposition information includes starting point information, and width and height information.

For example, a coordinate system is set for the decoration image 300. FIG. 3 shows a coordinate system in which an upper left vertex O of the decoration image 300 is an origin, a horizontal coordinate of the decoration image 300 is an M-axis, and a vertical coordinate is an N-axis. Hereinafter, the coordinate system set in the decoration image 300 is described as an MN coordinate system.

The starting point information is coordinate information indicating a position of a starting point serving as a reference when the content image 200 is disposed in the disposition portion 310. In the embodiment, an upper left vertex U of the disposition portion 310 is set as a starting point when viewed in the drawing. Coordinates of the vertex U in the MN coordinate system are denoted as (M1, N1).

The width information is information indicating a width W in an M-axis direction from the vertex U as the starting point. The height information is information indicating a height H in an N-axis direction from the vertex U as the starting point.

When the decoration image 300 to be combined with the content image 200 is selected by an operation on the remote control 10 by the user, the PJ controller 170 reads the selected decoration image 300 and disposition information on the decoration image 300 from the PJ storage 171. The PJ controller 170 outputs the read decoration image 300 and disposition information to the image processor 150.

When the decoration image 300 and the disposition information are input from the PJ controller 170, the image processor 150 loads the input decoration image 300 into the frame memory 140.

Next, the image processor 150 executes a reduction process. The image processor 150 executes the reduction process of reducing the content image 200 input from the image input I/F 130 in accordance with a size of the disposition portion 310.

First, the image processor 150 compares resolution of the content image 200 input from the image input I/F 130 with width and height information in the disposition information to calculate a reduction ratio at which the content image 200 is reduced. As an example, the reduction ratio is a ratio of resolution corresponding to the width W and the height H to the resolution of the content image 200, but a calculation method is not limited to this example.

After determining the reduction ratio, the image processor 150 executes a reduction process of reducing the content image 200 at the determined reduction ratio.

Next, the image processor 150 executes a combination process.

FIG. 4 shows the composite image 400 loaded into the frame memory 140. The composite image 400 shown in FIG. 4 is an example in which an image process such as shape correction is not performed by the image processor 150.

For example, a coordinate system is set in the frame memory 140. FIG. 4 shows, when viewed in the drawing, a coordinate system in which an upper left vertex O of the frame memory 140 is set as an origin, a horizontal coordinate of the frame memory 140 is an S axis, and a vertical coordinate is a T axis. In the following description, the coordinate system set in the frame memory 140 is described as an ST coordinate system.

The image processor 150 generates the composite image 400 in the frame memory 140 by superimposing the content image 200 reduced by the reduction process on the decoration image 300. The image processor 150 generates the composite image 400 having a size equal to or smaller than a maximum size of an image that can be loaded into the frame memory 140 in order to store the entire composite image 400 in the frame memory 140. The maximum size of the image that can be loaded into the frame memory 140 is the same as a maximum size of an image that can be drawn in the image forming region 164 of the liquid crystal panel 163.

In FIG. 4, coordinates of an upper left vertex V of the decoration image 300 loaded into the frame memory 140 are assumed to be (S0, T0). The image processor 150 calculates a coordinate value S1 by adding the coordinate value M1 in an M coordinate of the starting point information in the disposition information to S0, which is an S coordinate value of the upper left vertex V of the decoration image 300, as the S coordinate value of the vertex U in the ST coordinate system.

Similarly, the image processor 150 calculates a coordinate value T1 by adding the coordinate value N1 in an N coordinate of the starting point information in the disposition information to TO, which is a T coordinate value of the upper left vertex V of the decoration image 300, as the T coordinate value of the vertex U in the ST coordinate system.

Next, based on the disposition information and the coordinate values of the vertex U in the ST coordinate system, the image processor 150 superimposes the content image 200 reduced by the reduction process on the disposition portion 310 of the decoration image 300 loaded into the frame memory 140.

The image processor 150 generates the composite image 400 by superimposing the content image 200 on the disposition portion 310 of the decoration image 300 loaded into the frame memory 140 such that an upper left vertex of the content image 200 is located at the coordinates of the vertex U in the ST coordinate system. An image of the disposition portion 310 of the decoration image 300 loaded into the frame memory 140 before the content image 200 is superimposed is rewritten to the content image 200.

Accordingly, the content image 200 is loaded into a region of the frame memory 140 into which the disposition portion 310 of the decoration image 300 is loaded, and an image of the frame 330 is left in the frame memory 140 as it is. In the process, the composite image 400 is generated so that the disposition portion 310 of the decoration image 300 as the second image does not overlap the content image 200 as the first image.

After generating the composite image 400, the image processor 150 may perform, for example, an image process such as a resolution conversion process, a resizing process, distortion aberration correction, a shape correction process, a digital zoom process, and adjustment of hue or luminance of an image on the generated composite image 400. These image processes are not essential processes, and the image processor 150 may not execute the above image process. The image processor 150 may execute a combination of a plurality of image processes among the above image processes.

When the image process is ended, the image processor 150 reads the image information on the composite image 400 loaded into the frame memory 140, and outputs the read image information to the panel driver 167 of the image projection unit 160.

When the image information is input from the image processor 150, the image projection unit 160 applies a drive voltage corresponding to the input image information to each pixel of the image forming regions 164R, 164G, and 164B, and sets each pixel to light transmittance corresponding to the image information. A light emitted from the light source 161 is separated into R, G, and B color lights by the color separation optical system, and passes through the image forming regions 164R, 164G, and 164B of the liquid crystal panels 163R, 163G, and 163B. Accordingly, the color light is modulated for each pixel, and an image light corresponding to the image information is formed for each color light. The formed image lights with each color are combined for each pixel by a color composition optical system (not shown) to become an image light representing a color image, and is enlarged and projected on the screen 30 which is a projection surface by the projection lens 165. At this time, the composite image 400 displayed on the screen 30 is displayed on the screen 30 such that the frame 330 of the decoration image 300 and the content image 200 do not overlap.

### 3. Decoration Image Selection Method by Projector According to First Embodiment

Next, a selection method for selecting the decoration image 300 to be combined with the content image 200 will be described. The projector 100 has two modes, a preset mode and a partial image selection mode as a selection mode for selecting the decoration image 300 to be combined with the content image 200.

The preset mode corresponds to a first method, and is a mode in which the user selects the decoration image 300 from a plurality of decoration images 300 prepared in advance.

The partial image selection mode corresponds to a second method, and is a mode in which the decoration image 300 is divided into a plurality of regions and the user selects an image to be displayed in each of the divided regions. An image displayed in the divided region is the partial image 250.

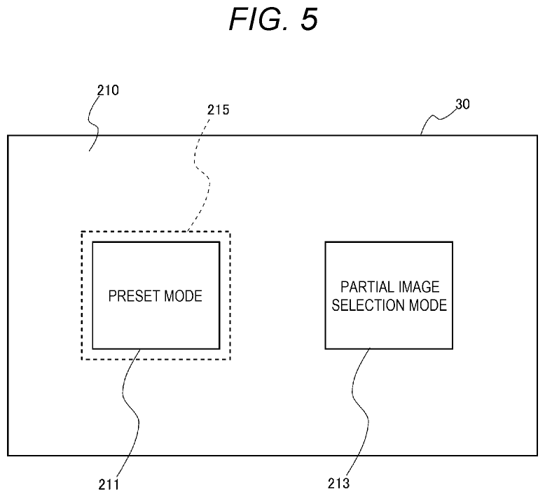

FIG. 5 is a diagram showing an example of a mode selection image 210 displayed on the screen 30.

For example, it is assumed that the combination button on the remote control 10 is turned on and an instruction to display the composite image 400 is input to the PJ controller 170. When the instruction to display the composite image 400 is input, the PJ controller 170 displays the mode selection image 210 shown in FIG. 5 on the screen 30. The mode selection image 210 corresponds to a second user interface image.

A selection image 211 and a selection image 213 are displayed in the mode selection image 210.

The selection image 211 is an image for selecting the preset mode. The selection image 213 is an image for selecting the partial image selection mode. As shown in FIG. 5, in the selection image 211, the preset mode is displayed in text, and in the selection image 213, the partial image selection mode is displayed in text.

In the mode selection image 210, a selection frame 215 indicated by a broken line is displayed in addition to the selection image 211 and the selection image 213. The selection frame 215 is an image indicating which selection button of the selection image 211 and the selection image 213 is in a selected state. The selection frame 215 is displayed so as to surround a periphery of the selection image 211 or the selection image 213.

A display position of the selection frame 215 in the mode selection image 210 is changed by operating a right direction key or a left direction key on the remote control 10. When the right direction key on the remote control 10 is pressed while the selection frame 215 surrounds the selection image 211, the PJ controller 170 changes a display of the mode selection image 210 so that the selection frame 215 surrounds the selection image 213. When the left direction key on the remote control 10 is pressed in a display state where the selection frame 215 surrounds the selection image 213, the PJ controller 170 changes the display of the mode selection image 210 so that the selection frame 215 surrounds the selection image 211.

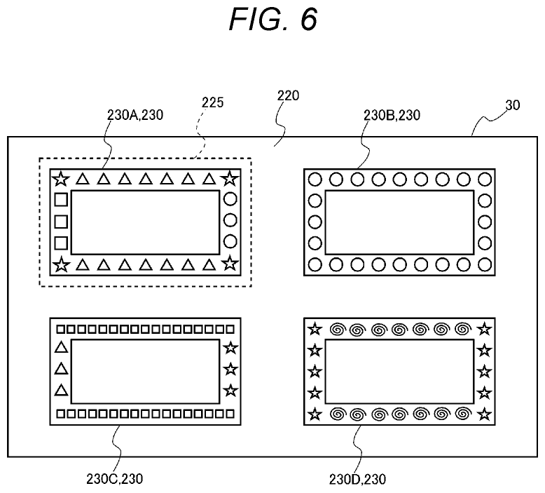

FIG. 6 is a diagram showing an example of a first selection image 220 displayed on the screen 30. The first selection image 220 corresponds to a first user interface image.

The first selection image 220 is an image displayed on the screen 30 when the enter key on the remote control 10 is pressed and the preset mode is selected, in a state where the selection frame 215 surrounds the periphery of the selection image 211.

When the enter key on the remote control 10 is pressed, the PJ controller 170 changes a display of the screen 30 from the mode selection image 210 shown in FIG. 5 to the first selection image 220 shown in FIG. 6.

A plurality of preset images 230 are displayed in the first selection image 220. Any two of the plurality of preset images 230 respectively correspond to an image indicating a first combination or an image indicating a second combination.

The preset image 230 is a reduced image obtained by reducing the decoration image 300, and may be generated by the PJ controller 170 based on the decoration image 300 or may be stored in the PJ storage 171 in advance. In the first selection image 220 shown in FIG. 6, four preset images 230, a first preset image 230A, a second preset image 230B, a third preset image 230C, and a fourth preset image 230D, are displayed. The number of preset images 230 displayed in the first selection image 220 is not limited to four, and may be less than four or more than four. When a plurality of preset images 230 are displayed on the first selection image 220 and cannot be displayed on one screen, five or more preset 230 may be displayed by displaying the first selection image 220 in a horizontally scrollable or vertically scrollable manner.

The first preset image 230A, the second preset image 230B, the third preset image 230C, and the fourth preset image 230D shown in FIG. 6 are images in which patterns of displayed images are different from each other. Accordingly, when a different preset image 230 is selected from the first selection image 220, an image of the first selected preset image 230 is different from an image of the second selected preset image 230. This means that an image selected as the image indicating the first combination and an image selected as the image indicating the second combination are different images.

In addition, the first preset image 230A, the second preset image 230B, the third preset image 230C, and the fourth preset image 230D may have different colors or may have at least one of different colors or patterns for each preset image 230. The first preset image 230A, the second preset image 230B, the third preset image 230C, and the fourth preset image 230D may have different shapes, such as widths and outlines, of the preset images 230. That is, the preset images 230 have different appearances.

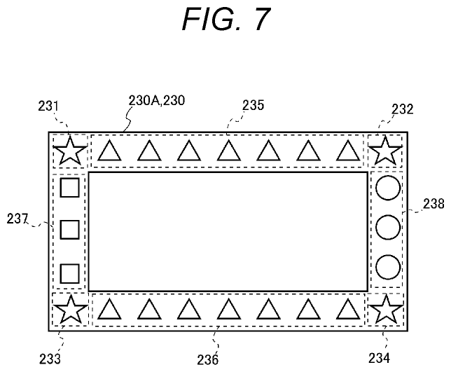

FIG. 7 is an enlarged view of the first preset image 230A.

The decoration image 300 can also be referred to as an image generated by combining a plurality of partial images 250. The same applies to the preset image 230 which is a reduced image of the decoration image 300. That is, the decoration image 300 can be said to be an image in which the partial images 250, which are part images constituting the plurality of decoration images 300, are selected in advance and the pre-selected partial images 250 are combined.

FIG. 7 shows a state where the first preset image 230A is divided into eight regions, a first region 231, a second region 232, a third region 233, a fourth region 234, a fifth region 235, a sixth region 236, a seventh region 237, and an eighth region 238, by broken lines. As shown in FIG. 7, the first region 231, the second region 232, the third region 233, the fourth region 234, the fifth region 235, the sixth region 236, the seventh region 237, and the eighth region 238 do not overlap each other.

One partial image 250 selected from a plurality of candidate images corresponding to the plurality of partial images 250 is disposed one by one in each of the regions 231 to 238 of the first preset image 230A divided into eight. The plurality of partial images 250 correspond to the plurality of candidate images. The partial image 250 displayed in any one of the regions 231 to 238 corresponds to a first partial image. The partial image 250 displayed in another one of the regions 231 to 238 corresponds to a second partial image. A plurality of candidate images that are candidates for the first partial image correspond to a plurality of first candidate images. A plurality of candidate images that are candidates for the second partial image correspond to a plurality of second candidate images. The plurality of first candidate images and the plurality of second candidate images may be the same or different.

For example, in the first region 231, the second region 232, the third region 233, and the fourth region 234 in the first preset image 230A, an image in which a star-shaped figure is displayed is selected in advance as the partial image 250. In the fifth region 235 and the sixth region 236, an image in which a plurality of triangular figures are displayed is selected in advance as the partial image 250. In the seventh region 237, an image in which a plurality of rectangular figures are displayed is selected in advance as the partial image 250. In the eighth region 238, an image in which a plurality of circular figures are displayed is selected in advance as the partial image 250. Accordingly, a combination of the partial images 250 selected in the first region 231 to the eighth region 238 includes one of the plurality of first candidate images and one of the plurality of second candidate images, and corresponds to the first combination or the second combination.

Although FIG. 7 shows the first preset image 230A, the same applies to the second preset image 230B, the third preset image 230C, and the fourth preset image 230D.

In the second preset image 230B, the third preset image 230C, and the fourth preset image 230D as well, one partial image 250 selected from the plurality of partial images 250 stored in the PJ storage 171 is disposed in each of the first region 231 to the eighth region 238. Accordingly, the first combination or the second combination is formed. The plurality of partial images 250 stored in the PJ storage 171 correspond to the plurality of candidate images.

Although FIG. 6 shows an example in which images having different patterns are displayed as the preset image 230, the images displayed as the preset image 230 may be images having the same color and the same pattern, and having different pattern dispositions. In other words, two preset images 230 having different pattern dispositions have different dispositions of candidate images. For example, it is assumed that the first preset image 230A is an image in which star-shaped figures are disposed in the first region 231, the second region 232, the third region 233, and the fourth region 234, and triangular figures are disposed in the fifth region 235, the sixth region 236, the seventh region 237, and the eighth region 238. At this time, the second preset image 230B may be an image in which triangular figures are disposed in the first region 231, the second region 232, the third region 233, and the fourth region 234, and star-shaped figures are disposed in the fifth region 235, the sixth region 236, the seventh region 237, and the eighth region 238.

Returning to FIG. 6, the description of the first selection image 220 will be continued.

The selection frame 225 is displayed in the first selection image 220.

The selection frame 225 is displayed to surround a periphery of any one of the first preset image 230A to the fourth preset image 230D. A display position of the selection frame 225 in the first selection image 220 is changed by operating any one of the upper, lower, left, and right direction keys provided on the remote control 10. FIG. 6 shows a state where the selection frame 225 surrounds the periphery of the first preset image 230A.

When the enter key provided on the remote control 10 is pressed in a state where any one of the first preset image 230A to the fourth preset image 230D is surrounded by the selection frame 225, the PJ controller 170 determines that the preset image 230 whose periphery is surrounded by the selection frame 225 is selected.

In a state where the selection frame 225 surrounds any one of the first preset image 230A to the fourth preset image 230D, an operation of pressing the enter key provided on the remote control 10 corresponds to an operation of selecting an image indicating the first combination, and the selected preset image 230 corresponds to the image indicating the first combination. The operation of selecting the preset image 230 may be another known selection operation, and a display for indicating the selected preset image 230 may be an expression other than the selection frame 225. Acquiring an operation signal from the remote control 10 or the like by the PJ controller 170 corresponds to receiving an operation.

When the enter key is pressed and the preset image 230 is selected, the PJ controller 170 reads, from the PJ storage 171, the decoration image 300 that is a source of the preset image 230 and the disposition information, and outputs the read decoration image 300 and disposition information to the image processor 150.

The image processor 150 loads the decoration image 300 input from the PJ controller 170 into the frame memory 140, and executes a reduction process of reducing the content image 200 input from the image input I/F 130 in accordance with the size of the disposition portion 310 based on the disposition information.

Next, the image processor 150 loads the content image 200 subjected to the reduction process on the disposition portion 310 of the decoration image 300 loaded into the frame memory 140 to generate the composite image 400. Accordingly, the image of the disposition portion 310 is rewritten to the content image 200. Thereafter, the image processor 150 performs an image process such as a resolution conversion process, a resizing process, and a shape correction process on the composite image 400, and outputs image information on the composite image 400 after the image process to the image projection unit 160. The image projection unit 160 generates an image light corresponding to the input image information and projects the generated image light onto the screen 30, so that the composite image 400 is displayed on the screen 30.

FIG. 8 is a diagram showing an example of a second selection image 240 displayed on the screen 30. The second selection image 240 corresponds to the first user interface image. The second selection image 240 is an image displayed on the screen 30 when the enter key on the remote control 10 is pressed, in a state where the selection frame 215 surrounds the periphery of the selection image 213.

Next, an operation when the selection image 213 shown in FIG. 5 is selected and the partial image selection mode is selected will be described. When the enter key on the remote control 10 is pressed, the PJ controller 170 changes a display of the screen 30 from the mode selection image 210 shown in FIG. 5 to the second selection image 240 shown in FIG. 8.

A plurality of partial images 250 are displayed in the second selection image 240. FIG. 8 shows an example in which eight partial images 250 are displayed. The eight partial images 250 are respectively displayed in eight regions 260 obtained by dividing the decoration image 300 into eight regions. The eight regions 260 include a first region 261, a second region 262, a third region 263, a fourth region 264, a fifth region 265, a sixth region 266, a seventh region 267, and an eighth region 268. As shown in FIG. 8, the first region 261, the second region 262, the third region 263, the fourth region 264, the fifth region 265, the sixth region 266, the seventh region 267, and the eighth region 268 are regions that do not overlap the other regions 260.

The partial image 250 displayed in the first region 261 is referred to as a partial image 251 in the first region 261. The partial image 250 displayed in the second region 262 is referred to as a partial image 252 in the second region 262. The partial image 250 displayed in the third region 263 is referred to as a partial image 253 in the third region 263. The partial image 250 displayed in the fourth region 264 is referred to as a partial image 254 in the fourth region 264. The partial image 250 displayed in the fifth region 265 is referred to as a partial image 255 in the fifth region 265. The partial image 250 displayed in the sixth region 266 is referred to as a partial image 256 in the sixth region 266. The partial image 250 displayed in the seventh region 267 is referred to as a partial image 257 in the seventh region 267. The partial image 250 displayed in the eighth region 268 is referred to as a partial image 258 in the eighth region 268.

The partial images 250 displayed in the respective regions 260 of the first region 261 to the eighth region 268 can be changed individually by an operation of the user. The user can change the partial image 250 displayed in each region 260 by operating the remote control 10.

A selection frame 245, a left arrow image 246, and a right arrow image 247 indicated by broken lines are displayed in the second selection image 240. First, the user operates the direction key on the remote control 10 to move the selection frame 245 to the region 260 where the user wants to change the partial image 250. FIG. 8 shows a state where the first region 261 is surrounded by the selection frame 245 and the first region 261 is selected. When the user moves the selection frame 245 to the region 260 where the user wants to change the partial image 250, the user presses the enter key on the remote control 10. When the enter key on the remote control 10 is pressed, the PJ controller 170 determines that the region 260 surrounded by the selection frame 245 is selected, and displays the left arrow image 246 and the right arrow image 247 in the selected region 260.

The left arrow image 246 and the right arrow image 247 indicate directions in which the projector 100 receives an operation by the direction key on the remote control 10. The left arrow image 246 indicates that the projector 100 receives an operation of the left direction key. The right arrow image 247 indicates that the projector 100 receives an operation of the right direction key on the remote control 10.

When the user presses the right direction key or the left direction key on the remote control 10, the partial image 251 in the first region 261 displayed in the first region 261 is changed. The PJ controller 170 changes the partial image 251 in the first region 261 every time an operation of the right direction key or the left direction key on the remote control 10 is received.

The PJ storage 171 stores setting data indicating a display order of the plurality of partial images 250. Every time the right direction key or the left direction key on the remote control 10 is pressed, the PJ controller 170 selects one of the partial images 250 according to the setting data, and displays, in the first region 261, the selected partial image 250 as the partial image 251 in the first region 261.

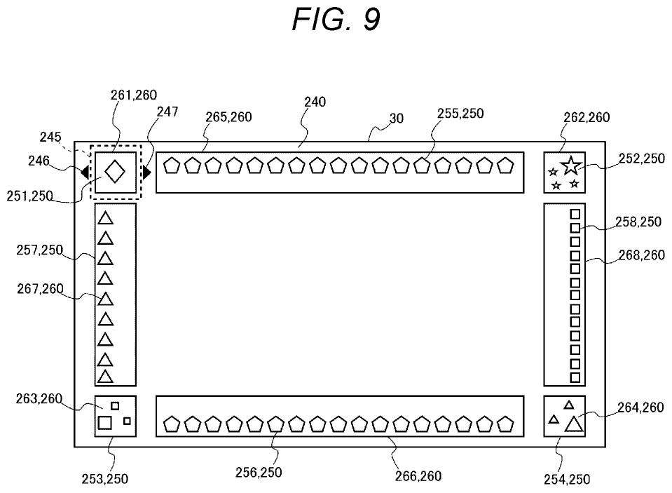

FIG. 9 is a diagram showing the partial image 251 in the first region 261 after a change.

When the partial image 251 in the first region 261 to be displayed is displayed in the first region 261, the user presses the enter key on the remote control 10. When the enter key is pressed, the PJ controller 170 becomes ready to receive an operation to move the selection frame 245 from the first region 261.

The partial image 251 in the first region 261 to the partial image 258 in the eighth region 268 displayed in each region 260, which is the first region 261 to the eighth region 268, and the selection frame 245 correspond to images for receiving an operation of selecting one of the plurality of first candidate images as a candidate for the first partial image and an operation of selecting one of the plurality of second candidate images as a candidate for the second partial image.

With respect to the second region 262 to the eighth region 268, the user performs a similar operation as in the case of the first region 261 to display the partial image 250 selected by the user in each region 260, which is the first region 261 to the eighth region 268.

When the selected partial image 250 is displayed in the first region 261 to the eighth region 268, the user inputs a predetermined operation set in advance to the remote control 10. The predetermined operation may be an operation of another button provided on the remote control 10 or a long press operation of the enter key. In the embodiment, a case where the predetermined operation is a long press operation of the enter key will be described.

When the PJ controller 170 receives the long press operation of the enter key, the PJ controller 170 outputs, to the image processor 150, the selected partial image 250 in each region 260, coordinate information indicating coordinates of the frame memory 140 in which the partial image 250 is disposed, and disposition information.

In the second selection image 240, the partial images 250 read from the PJ storage 171 and displayed in the first region 261 to the eighth region 268 before a predetermined operation is input correspond to the first candidate image and the second candidate image.

In the second selection image 240, the partial images 250 displayed in the first region 261 to the eighth region 268 when a predetermined operation is input correspond to the first partial image and the second partial image.

The image processor 150 loads the plurality of partial images 250 input from the PJ controller 170 into the frame memory 140 according to the coordinate information. Thereafter, the image processor 150 executes a reduction process of reducing the content image 200 input from the image input I/F 130 in accordance with the size of the disposition portion 310 based on the disposition information.

Next, the image processor 150 loads the content image 200 subjected to the reduction process on the disposition portion 310 of the decoration image 300 loaded into the frame memory 140 to generate the composite image 400. Accordingly, the image of the disposition portion 310 is rewritten to the content image 200.

Thereafter, the image processor 150 performs an image process such as a resolution conversion process, a resizing process, and a shape correction process on the composite image 400, and outputs image information on the composite image 400 after the image process to the image projection unit 160. The image projection unit 160 generates an image light corresponding to the input image information and projects the generated image light onto the screen 30, so that the composite image 400 is displayed on the screen 30.

Although FIGS. 7 to 9 show an example in which the decoration image 300 is divided into eight regions, the first region 261 to the eighth region 268, the number of divisions of the decoration image 300 may be other than eight.

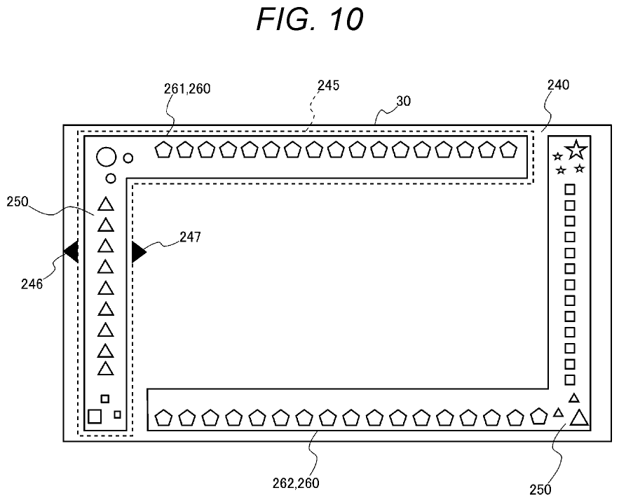

FIG. 10 is a diagram showing another example of the second selection image 240 displayed on the screen 30.

The second selection image 240 shown in FIG. 10 shows an example in which the decoration image 300 is divided into two regions 260, the first region 261 and the second region 262.

The first region 261 is a region for selecting the partial image 250 disposed at an upper side of the content image 200 displayed on the screen 30 and at a left side of the content image 200 toward the screen 30, when the decoration image 300 is combined with the content image 200 and displayed on the screen 30. The second region 262 is a region for selecting the partial image 250 disposed at a lower side of the content image 200 displayed on the screen 30 and at a right side of the content image 200 toward the screen 30, when the decoration image 300 is combined with the content image 200 and displayed on the screen 30. In the example in FIG. 10 as well, the first region 261 and the second region 262 do not overlap.

When the decoration image 300 is divided into two regions 260, the first region 261 and the second region 262 shown in FIG. 10, the partial image 250 having a shape corresponding to shapes of the first region 261 and the second region 262 may be stored in the PJ storage 171 in advance. That is, an image obtained by combining the partial images 250 disposed in the first region 261, the third region 263, the fifth region 265, and the seventh region 267 shown in FIG. 8 is stored in the PJ storage 171 as the partial image 250 corresponding to the first region 261. Similarly, an image obtained by combining the partial images 250 disposed in the second region 262, the fourth region 264, the sixth region 266, and the eighth region 268 shown in FIG. 8 is stored in the PJ storage 171 as the partial image 250 corresponding to the second region 262.

When the second selection image 240 shown in FIG. 10 is displayed on the screen 30, the PJ controller 170 may combine the partial images 250 in the first region 261 to the eighth region 268 shown in FIG. 8 to generate the partial image 250 corresponding to the shape of the first region 261 shown in FIG. 10. The same applies to the second region 262.

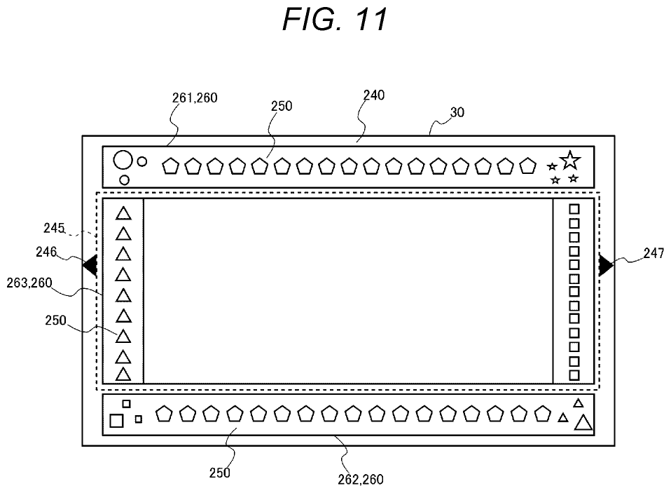

FIG. 11 is a diagram showing another example of the second selection image 240 displayed on the screen 30.

The second selection image 240 shown in FIG. 11 shows an example in which the decoration image 300 is divided into three regions 260, the first region 261, the second region 262, and the third region 263.

The first region 261 is a region for selecting the partial image 250 disposed at the upper side of the content image 200 displayed on the screen 30, when the decoration image 300 is combined with the content image 200 and displayed on the screen 30.

The second region 262 is a region for selecting the partial image 250 disposed at the lower side of the content image 200 displayed on the screen 30, when the decoration image 300 is combined with the content image 200 and displayed on the screen 30.

The third region 263 is a region for selecting the partial images 250 displayed at a left side and a right side of the content image 200 displayed on the screen 30, when the decoration image 300 is combined with the content image 200 and displayed on the screen 30.

When the second selection image 240 shown in FIG. 11 is displayed on the screen 30 as well, the partial images 250 corresponding to shapes of the first region 261, the second region 262, and the third region 263 may be stored in the PJ storage 171 in advance. When the second selection image 240 shown in FIG. 11 is displayed on the screen 30, the partial images 250 in the first region 261 to the eighth region 268 shown in FIG. 8 may be combined to generate the partial image 250 corresponding to the shape of the first region 261 shown in FIG. 11.

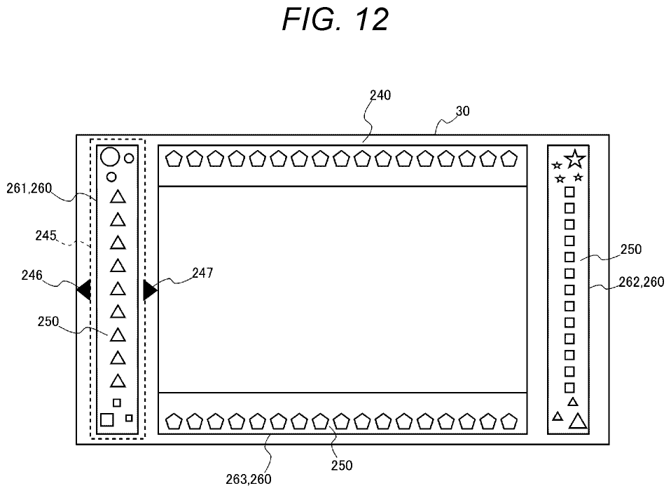

FIG. 12 is a diagram showing another example of the second selection image 240 displayed on the screen 30.

The second selection image 240 shown in FIG. 12 also shows an example in which the decoration image 300 is divided into three regions 260, the first region 261, the second region 262, and the third region 263.

The first region 261 is a region for selecting the partial image 250 disposed at the left side of the content image 200 displayed on the screen 30, when the decoration image 300 is combined with the content image 200 and displayed on the screen 30.

The second region 262 is a region for selecting the partial image 250 disposed at the right side of the content image 200 displayed on the screen 30, when the decoration image 300 is combined with the content image 200 and displayed on the screen 30.

The third region 263 is a region for selecting the partial images 250 disposed at the upper side and the lower side of the content image 200 displayed on the screen 30, when the decoration image 300 is combined with the content image 200 and displayed on the screen 30.

When the second selection image 240 shown in FIG. 12 is displayed on the screen 30 as well, the partial images 250 corresponding to shapes of the first region 261, the second region 262, and the third region 263 may be stored in the PJ storage 171 in advance. When the second selection image 240 shown in FIG. 12 is displayed on the screen 30, the partial images 250 in the first region 261 to the eighth region 268 shown in FIG. 8 may be combined to generate the partial image 250 corresponding to the shape of the first region 261 shown in FIG. 12.

### 4. Operation of Projector According to First Embodiment

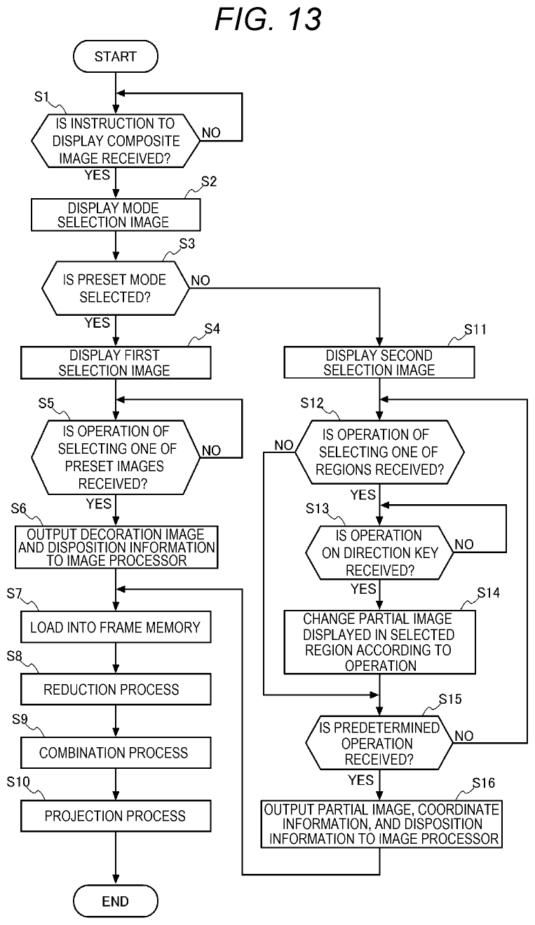

FIG. 13 is a flowchart showing an operation of the projector 100.

The operation of the projector 100 will be described with reference to the flowchart shown in FIG. 13.

First, the PJ controller 170 determines whether the combination button on the remote control 10 is turned on and whether an instruction to display the composite image 400 is received from the remote control 10 (step S1). When the instruction to display the composite image 400 is not received (step S1: NO), the PJ controller 170 waits until the PJ controller 170 receives the instruction to display the composite image 400.

When the PJ controller 170 receives the instruction to display the composite image 400 from the remote control 10 (step S1: YES), the PJ controller 170 displays the mode selection image 210 shown in FIG. 5 on the screen 30 (step S2). Next, the PJ controller 170 determines whether the preset mode is selected by determining whether an operation of selecting the selection image 211 is received from the remote control 10 (step S3). In step S3, when an operation of selecting the selection image 211 is received, the PJ controller 170 determines that the preset mode is selected.

When the PJ controller 170 determines that the preset mode is selected (step S3: YES), the PJ controller 170 displays the first selection image 220 shown in FIG. 6 on the screen 30 (step S4).

Next, the PJ controller 170 determines whether an operation of selecting one of the preset images 230 displayed in the first selection image 220 is received from the remote control 10 (step S5). In step S5, the PJ controller 170 determines whether any one of the first preset image 230A, the second preset image 230B, the third preset image 230C, and the fourth preset image 230D displayed in the first selection image 220 is selected.

Next, when the PJ controller 170 does not receive the operation of selecting one of the preset images 230 from the remote control 10 (step S5: NO), the PJ controller 170 waits until the PJ controller 170 receives the operation of selecting one of the preset images 230 from the remote control 10.

When the PJ controller 170 receives the operation of selecting one of the preset images 230 from the remote control 10 (step S5: YES), the PJ controller 170 reads, from the PJ storage 171, the decoration image 300 that is a source of the selected preset image 230 and disposition information. The PJ controller 170 outputs the read decoration image 300 and disposition information to the image processor 150 (step S6).

The image processor 150 loads the decoration image 300 input from the PJ controller 170 into the frame memory 140 according to the disposition information (step S7). Next, the image processor 150 performs a reduction process (step S8). The image processor 150 reduces the content image 200 input from the image input I/F 130 in accordance with the size of the disposition portion 310 based on the disposition information.

Next, the image processor 150 executes a combination process (step S9). The image processor 150 executes a combination process of loading the content image 200 subjected to the reduction process on the disposition portion 310 of the decoration image 300 loaded into the frame memory 140 to generate the composite image 400.

Next, the image processor 150 performs an image process such as a resolution conversion process, a resizing process, and a shape correction process on the composite image 400, and outputs image information on the composite image 400 after the image process to the image projection unit 160.

The image projection unit 160 executes a projection process based on the input image information (step S10). The image projection unit 160 applies a drive voltage corresponding to the image information input from the image processor 150 to each pixel of the image forming regions 164R, 164G, and 164B, and sets each pixel to light transmittance corresponding to the image information. A light emitted from the light source 161 is separated into R, G, and B color lights by the color separation optical system, and passes through the image forming regions 164R, 164G, and 164B of the liquid crystal panels 163R, 163G, and 163B. Accordingly, the color light is modulated for each pixel, and an image light corresponding to the image information is formed for each color light. The formed image lights with each color are combined for each pixel by a color composition optical system (not shown) to become an image light representing a color image, and is enlarged and projected on the screen 30 which is a projection surface by the projection lens 165.

Next, an operation when the partial image selection mode is selected instead of the preset mode by determining whether an operation of selecting the selection image 213 is received by an operation of the remote control 10 will be described.

When an operation of selecting the selection image 213 is received, the PJ controller 170 determines that the partial image selection mode is selected instead of the preset mode (step S3: NO). In this case, the PJ controller 170 displays the second selection image 240 shown in FIG. 8 on the screen 30 (step S11).

Next, the PJ controller 170 determines whether an operation of selecting one of the plurality of regions 260 displayed in the second selection image 240 is received (step S12). When the PJ controller 170 does not receive the operation of selecting one of the plurality of displayed regions 260 (step S12: NO), the process proceeds to determination in step S15. The determination in step S15 will be described later.

When the PJ controller 170 receives the operation of selecting one of the plurality of displayed regions 260 (step S12: YES), the PJ controller 170 determines whether an operation on the direction key is received (step S13). The PJ controller 170 determines whether any one of the left direction key and the right direction key provided on the remote control 10 is operated.

When the operation on the left direction key or the right direction key is not received (step S13: NO), the PJ controller 170 waits until the operation of the direction key is received.

When the operation on the left direction key or the right direction key is received (step S13: YES), the PJ controller 170 changes the partial image 250 displayed in the region 260 selected in step S12 according to the operation on the direction key (step S14).

Next, the PJ controller 170 determines whether a predetermined operation is received (step S15). The predetermined operation is an operation indicating that selection of the partial images 250 displayed in the plurality of regions 260 in the second selection image 240 is ended. The predetermined operation may be, for example, a long press of the enter key or an operation of another button provided on the remote control 10.

When the predetermined operation is not received (step S15: NO), the PJ controller 170 returns to the determination in step S12. When the predetermined operation is received (step S15: YES), the PJ controller 170 outputs, to the image processor 150, the partial image 250 selected in the region 260, coordinate information indicating coordinates of the frame memory 140 in which the partial image 250 is disposed, and disposition information (step S16). Thereafter, the image processor 150 loads the partial image 250 into the frame memory 140 according to the coordinate information (step S7), and performs a reduction process on the content image 200 input from the image input I/F 130 according to the disposition information (step S8).

Next, the image processor 150 executes a combination process of loading the content image 200 subjected to the reduction process on the disposition portion 310 of the decoration image 300 loaded into the frame memory 140 to generate the composite image 400 (step S9).

Next, the image processor 150 performs an image process such as a resolution conversion process, a resizing process, and a shape correction process on the composite image 400, and outputs image information on the composite image 400 after the image process to the image projection unit 160. The image projection unit 160 executes a projection process (step S10), and displays an image light corresponding to the image information on the screen 30.

### 5. Second Embodiment

Next, a second embodiment will be described.

Since a configuration of the projector 100 according to the second embodiment is the same as that of the first embodiment, the same reference signs are used for the configuration of the projector 100, and a detailed description thereof will be omitted.

In the projector 100 according to the second embodiment, the decoration image 300 is displayed in a double manner. The projector 100 according to the second embodiment further displays a decoration image 300 inside the decoration image 300. In the second embodiment, the decoration image 300 displayed at an outer side is referred to as an outer decoration image 300A, and the decoration image 300 displayed at an inner side is referred to as an inner decoration image 300B. The inner decoration image 300B corresponds to a third image.

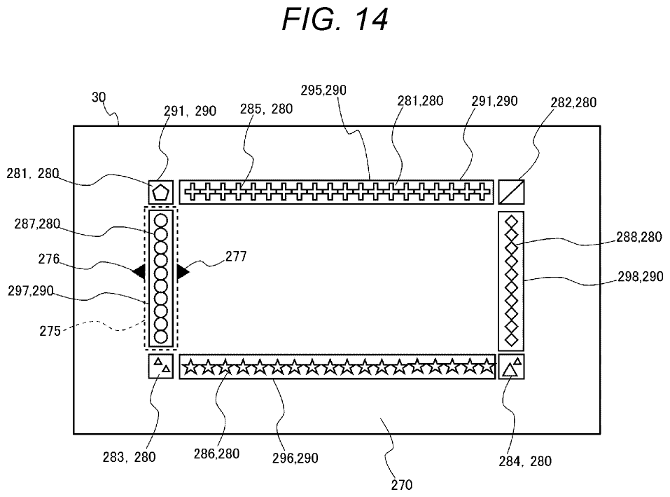

FIG. 14 is a diagram showing a third selection image 270. The third selection image 270 corresponds to a third user interface image.

A plurality of partial images 280 are displayed in the third selection image 270 shown in FIG. 14. FIG. 14 shows an example in which eight partial images 280 are displayed. The eight partial images 280 are respectively displayed in eight regions 290 obtained by dividing the decoration image 300 into eight regions. The eight regions 290 include a ninth region 291, a tenth region 292, an eleventh region 293, a twelfth region 294, a thirteenth region 295, a fourteenth region 296, a fifteenth region 297, and a sixteenth region 298.

The partial image 280 displayed in the ninth region 291 is referred to as a partial image 281 in the ninth region 291. The partial image 280 displayed in the tenth region 292 is referred to as a partial image 282 in the tenth region 292. The partial image 280 displayed in the eleventh region 293 is referred to as a partial image 283 in the eleventh region 293. The partial image 280 displayed in the twelfth region 294 is referred to as a partial image 284 in the twelfth region 294. The partial image 280 displayed in the thirteenth region 295 is referred to as a partial image 285 in the thirteenth region 295. The partial image 280 displayed in the fourteenth region 296 is referred to as a partial image 286 in the fourteenth region 296. The partial image 280 displayed in the fifteenth region 297 is referred to as a partial image 287 in the fifteenth region 297. The partial image 280 displayed in the sixteenth region 298 is referred to as a partial image 288 in the sixteenth region 298.

A selection frame 275, a left arrow image 276, and a right arrow image 277 are displayed in the third selection image 270. The selection frame 275 is an image surrounding a periphery of any one of the ninth region 291 to the sixteenth region 298. The left arrow image 276 is an image indicating that the projector 100 receives an operation of the left direction key on the remote control 10. The right arrow image 277 is an image indicating that the projector 100 receives an operation of the right direction key on the remote control 10.

A method for selecting the partial image 281 in the ninth region 291 to the partial image 288 in the sixteenth region 298 displayed in the ninth region 291 to the sixteenth region 298 is the same as a method for selecting the partial image 251 in the first region 261 to the partial image 258 in the eighth region 268 described in FIG. 8.

In the third selection image 270, the partial images 250 read from the PJ storage 171 and displayed in the ninth region 291 to the sixteenth region 298 before a predetermined operation is input correspond to a third candidate image and a fourth candidate image.

In the third selection image 270, the partial images 250 displayed in the ninth region 291 to the sixteenth region 298 when a predetermined operation is input correspond to the third partial image and the fourth partial image.

In the third selection image 270 shown in FIG. 14, to simplify the diagram, the partial image 251 in the first region 261 to the partial image 258 in the eighth region 268 are not displayed, but the partial image 251 in the first region 261 to the partial image 258 in the eighth region 268 may be displayed.

The PJ controller 170 outputs, to the image processor 150, the partial image 250 constituting the outer decoration image 300A, the partial image 250 constituting the inner decoration image 300B, coordinate information indicating the coordinates of the frame memory 140 in which the partial image 250 is disposed, and disposition information.

The image processor 150 loads the partial image 250 constituting the outer decoration image 300A into the frame memory 140 according to the input coordinate information. Next, the image processor 150 performs a reduction process on the content image 200 according to the input disposition information, and disposes the content image 200 subjected to the reduction process at the disposition portion 310 of the outer decoration image 300A. Further, the image processor 150 loads the partial image 250 constituting the inner decoration image 300B into the frame memory 140 according to the input coordinate information. At this time, the image processor 150 loads the partial image 250 constituting the inner decoration image 300B into the frame memory 140 according to the coordinate information, so that the inner decoration image 300B is superimposed on at least a part of the content image 200.

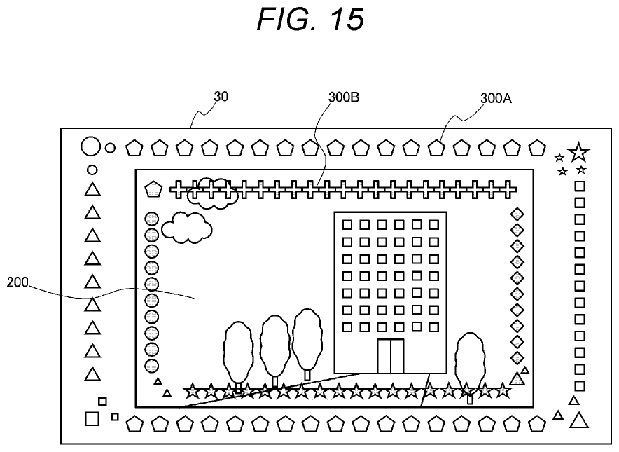

FIG. 15 shows a projection image displayed on the screen 30.

The outer decoration image 300A and the inner decoration image 300B are displayed in the projection image. The outer decoration image 300A is displayed outside the content image 200 along an outline of the content image 200. The inner decoration image 300B is displayed along the outline of the content image 200 so as to at least partially overlap the content image 200. The inner decoration image 300B may be displayed such that the entire inner decoration image 300B overlaps the content image 200, or may be displayed outside the content image 200 similarly to the outer decoration image 300A.

The inner decoration image 300B is displayed so as to at least partially overlap the content image 200. Therefore, transmittance of the inner decoration image 300B may be changed by an operation on the remote control 10 or the like. In the examples in FIGS. 14 and 15, the outer decoration image 300A and the inner decoration image 300B do not overlap, but the outer decoration image 300A and the inner decoration image 300B may at least partially overlap.

### 6. Third Embodiment

Next, a third embodiment will be described.

In the third embodiment, the same components as those in the above-described embodiments are denoted by the same reference signs, and a detailed description thereof will be omitted.

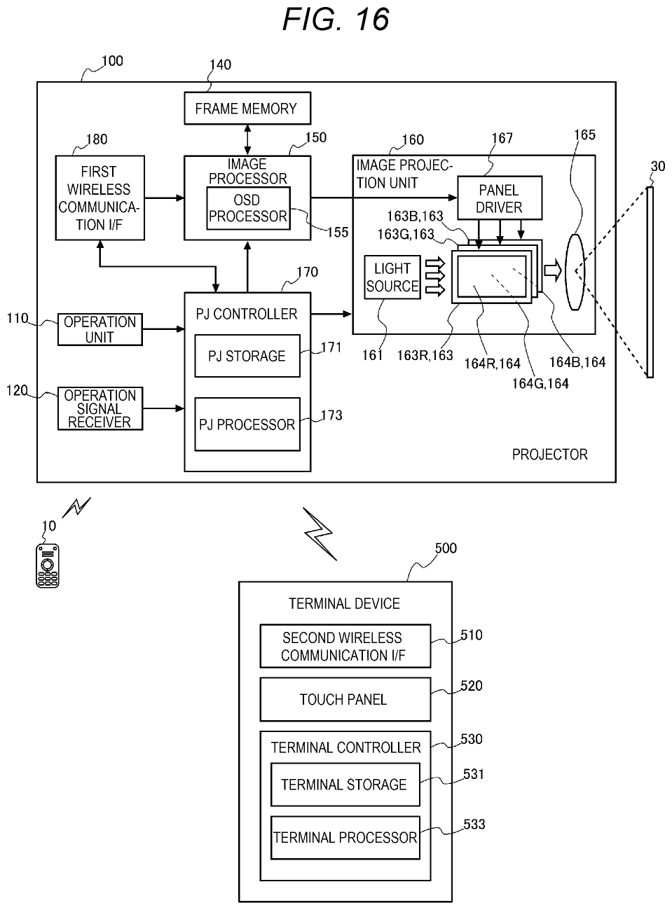

FIG. 16 is a block diagram showing a system configuration according to the third embodiment.

The projector 100 shown in FIG. 1 is wired to the information processing device 50, but the projector 100 shown in FIG. 16 includes a first wireless communication I/F 180 and is wirelessly connected to a terminal device 500.

The first wireless communication I/F 180 includes a network card (not shown) and performs wireless communication by a wireless local area network (LAN). The first wireless communication I/F 180 according to the embodiment performs wireless communication using Wi-Fi. Wi-Fi is a registered trademark.

The terminal device 500 is an external device that supplies an image signal to the projector 100, and for example, a smartphone or a tablet personal computer is used.

The terminal device 500 includes a second wireless communication I/F 510, a touch panel 520, and a terminal controller 530.

The second wireless communication I/F 510 includes a network card (not shown) and performs wireless communication using a wireless LAN. The second wireless communication I/F 510 according to the embodiment performs wireless communication using Wi-Fi.

The touch panel 520 includes a display panel and a touch sensor (not shown). For example, a liquid crystal panel or an organic electro-luminescence (EL) panel is used as the display panel. The touch sensor detects a touch operation of a user on the display panel. When a touch operation is detected, the touch sensor outputs, to the terminal controller 530, information indicating a position of the detected touch operation.

The terminal controller 530 is a computer device including a terminal storage 531 and a terminal processor 533.

The terminal storage 531 includes at least a nonvolatile memory such as a ROM, flash memory, or EEPROM.

The terminal storage 531 stores an application program. The terminal storage 531 also stores the content image 200, the decoration image 300, the partial image 250, and disposition information.

The terminal processor 533 is an arithmetic processing device including a processor such as a CPU or an MPU. The terminal processor 533 may be implemented with a single processor, or may be implemented with a plurality of processors.

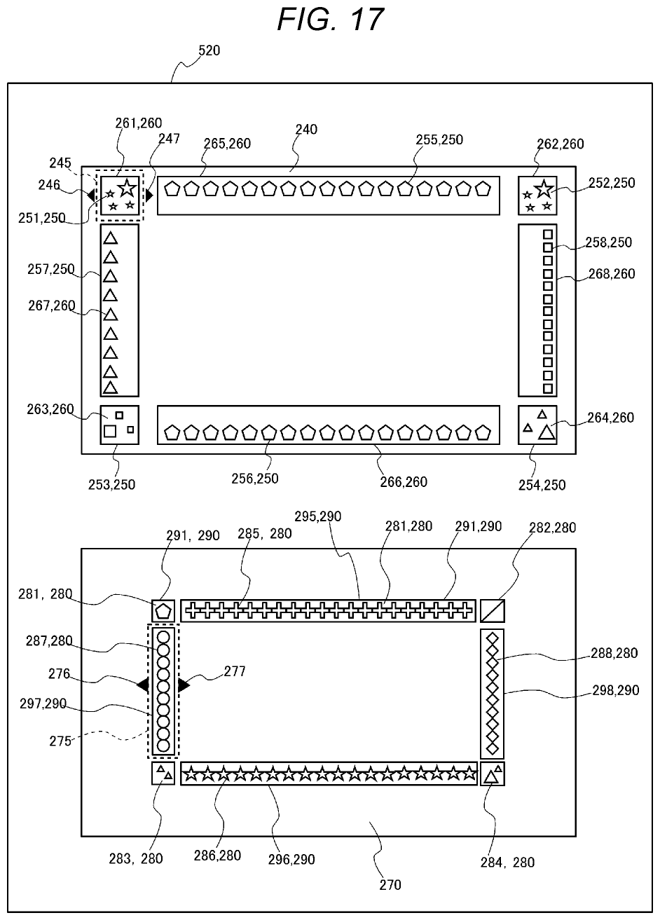

FIG. 17 is a diagram showing an example of a display screen displayed on the touch panel 520 by the terminal controller 530 that executes an application program.

An image including the second selection image 240 and the third selection image 270 is displayed on the touch panel 520.

Although FIG. 17 shows an example in which the second selection image 240 and the third selection image 270 are vertically displayed side by side, an order in which the third selection image 270 and the second selection image 240 are disposed is not limited. The touch panel 520 may be horizontally oriented, and the second selection image 240 and the third selection image 270 may be horizontally displayed side by side. Display positions of the second selection image 240 and the third selection image 270 may be switched by a touch operation on the touch panel 520. That is, in a display state shown in FIG. 17, when an operation of switching the display positions is input, the third selection image 270 is displayed above the second selection image 240.

Although FIG. 17 shows an example in which images including the second selection image 240 and the third selection image 270 are displayed, the second selection image 240 and the third selection image 270 may be sequentially displayed one by one on the touch panel 520.

The composite image 400, which is obtained by combining the partial image 251 in the first region 261 to the partial image 258 in the eighth region 268 selected in the second selection image 240 and the partial image 281 in the ninth region 291 to the partial image 288 in the sixteenth region 298 selected in the third selection image 270, may be displayed on the content image 200. That is, an image including the second selection image 240, the third selection image 270, and the composite image 400 may be displayed on the touch panel 520.

The user operates the touch panel 520 to select the partial image 251 in the first region 261 to the partial image 258 in the eighth region 268 in the second selection image 240. The user operates the touch panel 520 to select the partial image 281 in the ninth region 291 to the partial image 288 in the sixteenth region 298 in the third selection image 270.

When a predetermined operation such as a long press of the enter key is input, the terminal controller 530 combines the partial image 251 in the first region 261 to the partial image 258 in the eighth region 268 selected in the second selection image 240 to generate the outer decoration image 300A. The terminal controller 530 combines the partial image 281 in the ninth region 291 to the partial image 288 in the sixteenth region 298 selected in the third selection image 270 to generate the inner decoration image 300B.

Next, the terminal controller 530 combines the generated outer decoration image 300A and inner decoration image 300B with the content image 200 to generate the composite image 400.

The terminal controller 530 transmits an image signal of the generated composite image 400 to the projector 100.

When an image including the second selection image 240, the third selection image 270, and the composite image 400 is displayed on the touch panel 520, an image signal including a captured image obtained by capturing a screen of the touch panel 520 may be transmitted to the projector 100.

The projector 100 extracts the captured image in the image signal received from the terminal device 500, and displays, on the screen 30, the extracted captured image as a projection image.

### 7. Other Embodiments

Each of the above-described embodiments is a preferred embodiment. The present disclosure is not limited to the above-described embodiments, and various modifications can be made within the scope not departing from the gist.

For example, the information processing device 50 may display various images in the above-described embodiments and receive an operation. In this case, the information processing device 50 may transmit, to the projector 100, information for generating a projection image. When a smartphone is used as the remote control 10, the smartphone may execute a similar function.

In the first embodiment described above, when the content image 200 is superimposed on the disposition portion 310 of the decoration image 300 loaded into the frame memory 140, the frame 330 is disposed along the outline of the content image 200 outside the content image 200. The decoration image 300 and the content image 200 may be loaded into the frame memory 140 such that at least a part of the frame 330 overlaps the content image 200.

In the embodiment, a case where three transmissive liquid crystal panels 163 are provided as the light modulation device is described, but an embodiment of the present disclosure is not limited thereto. A light modulation element may be a reflective liquid crystal panel or a digital micromirror device. The number of display panels in the light modulation device is not limited, and may be, for example, one.

Each functional unit shown in FIGS. 1 and 16 shows a functional configuration, and a specific implementation form is not particularly limited. That is, it is needless to say that hardware corresponding to each functional unit is not necessarily implemented, and functions of a plurality of functional units may be implemented with one processor executing a program. In the above-described embodiments, a part of functions implemented with software may be implemented with hardware, or a part of functions implemented with hardware may be implemented with software.

When a display method and a program are implemented by using a computer in the projector 100, the program to be executed by the computer may be implemented in the form of a recording medium or a transmission medium for transmitting the program. A magnetic or optical recording medium, or a semiconductor memory device may be used as the recording medium. Specific examples include a portable or fixed recording medium such as a flexible disk, a hard disk drive (HDD), a CD-ROM, a DVD, a magneto-optical disk, a flash memory, and a card type recording medium. The recording medium may be a nonvolatile storage device such as a RAM, a ROM, or an HDD, which is an internal storage device in the server device.

### 8. Summary of Present Disclosure

Hereinafter, a summary of the present disclosure is appended below.

(Appendix 1) A display method including: receiving, via a first user interface image, an operation of determining a first combination of partial images including one of a plurality of first candidate images that are candidates for a first partial image and one of a plurality of second candidate images that are candidates for a second partial image; and displaying a second image including the first partial image and the second partial image corresponding to the first combination and disposed along an outline of a first image.

Accordingly, it is possible to receive an operation of determining the first combination of the partial images and display the second image including the first partial image and the second partial image corresponding to the first combination and disposed along the outline of the first image. Therefore, the first partial image and the second partial image in the second image can be selected from the plurality of first candidate images and the plurality of second candidate images, and a degree of freedom of presentation can be increased.

(Appendix 2) The display method according to Appendix 1, in which the first user interface image includes an image indicating the first combination including one of the plurality of first candidate images and one of the plurality of second candidate images, and an image indicating a second combination including one of the plurality of first candidate images and one of the plurality of second candidate images, the second combination being different from the image indicating the first combination, and the operation is an operation of selecting the image indicating the first combination.

Accordingly, it is possible to select, via the first user interface image, one of the image indicating the first combination and the image indicating the second combination different from the image indicating the first combination. Therefore, the displayed second image can be changed, and the degree of freedom of presentation can be increased.

(Appendix 3) The display method according to Appendix 1 or 2, in which the first user interface image includes an image for receiving an operation of selecting one of the plurality of first candidate images as a candidate for the first partial image and an operation of selecting one of the plurality of second candidate images as a candidate for the second partial image.

Accordingly, one of the plurality of first candidate images and one of the plurality of second candidate images can be selected via the first user interface image. Therefore, the first partial image and the second partial image in the second image can be selected from the plurality of first candidate images and the plurality of second candidate images, and the degree of freedom of presentation can be increased.

(Appendix 4) The display method according to Appendix 2, in which one of the plurality of first candidate images in the image indicating the first combination and one of the plurality of first candidate images in the image indicating the second combination have different appearances.

Accordingly, an appearance of the image indicating the first combination and an appearance of the image indicating the second combination can be changed, and the degree of freedom of presentation can be increased.

(Appendix 5) The display method according to Appendix 2, in which one of the plurality of first candidate images in the image indicating the first combination and one of the plurality of first candidate images in the image indicating the second combination have a same color and a same pattern, one of the plurality of second candidate images in the image indicating the first combination and one of the plurality of second candidate images in the image indicating the second combination have a same color and a same pattern, and a disposition of one of the plurality of first candidate images in the image indicating the first combination is different from a disposition of one of the plurality of first candidate images in the image indicating the second combination.

Accordingly, it is possible to select the image of the first combination and the image of the second combination in which the color and the pattern of the first candidate image and the second candidate image are the same but dispositions of at least one of the first candidate image and the second candidate image are different. Therefore, the degree of freedom of presentation can be increased.

(Appendix 6) The display method according to any one of Appendixes 1 to 5, further including: displaying a second user interface image for selecting any one of a first method and a second method, in which when the first method is selected, the first user interface image includes an image indicating a first combination including one of the plurality of first candidate images and one of the plurality of second candidate images, and an image indicating a second combination including one of the plurality of first candidate images and one of the plurality of second candidate images, the second combination being different from the image indicating the first combination, and when the second method is selected, the first user interface image includes an image for receiving an operation of selecting one of the plurality of first candidate images as a candidate for the first partial image and an operation of selecting one of the plurality of second candidate images as a candidate for the second partial image.

Accordingly, either the first method or the second method can be selected via the second user interface image. Therefore, it is possible to increase the degree of freedom in selecting an image to be displayed as the second image.

(Appendix 7) The display method according to any one of Appendixes 1 to 6, further including: receiving, via a third user interface image, an operation of determining a third combination of partial images including one of a plurality of third candidate images that are candidates for a third partial image and one of a plurality of fourth candidate images that are candidates for a fourth partial image, in which displaying the second image includes displaying the second image and a third image that includes the third partial image and the fourth partial image corresponding to the third combination and that is disposed along the outline of the first image.

Accordingly, it is possible to display the third image, which includes the third partial image that is one of the plurality of third candidate images and the fourth partial image that is one of the plurality of fourth candidate images and which is disposed along the outline of the first image. Therefore, the second image and the third image disposed along the outline of the first image can be displayed, and the degree of freedom of presentation can be increased.

(Appendix 8) The display method according to any one of Appendixes 1 to 7, in which the first partial image is disposed in a first region for the second image, and the second partial image is disposed in a second region for the second image that does not overlap the first region.

Accordingly, the first partial image is disposed in the first region for the second image, and the second partial image is disposed in the second region for the second image that does not overlap the first region. Therefore, a partial image to be disposed can be selected for each region for the second image.

(Appendix 9) A display device including: an optical device; and at least one processor, in which the at least one processor executes operations of displaying a first user interface image by controlling the optical device, receiving, via the first user interface image, an operation of determining t combination of partial images including one of a plurality of first candidate images that are candidates for a first partial image and one of a plurality of second candidate images that are candidates for a second partial image, and displaying, by controlling the optical device, a second image including the first partial image and the second partial image corresponding to the first combination and disposed along an outline of a first image.

Accordingly, it is possible to receive an operation of determining the first combination of the partial images and display the second image including the first partial image and the second partial image corresponding to the first combination and disposed along the outline of the first image. Therefore, the first partial image and the second partial image in the second image can be selected from the plurality of first candidate images and the plurality of second candidate images, and a degree of freedom of presentation can be increased.

(Appendix 10) A non-transitory computer-readable storage medium storing a program, the program causing a computer to execute operations including: receiving, via a first user interface image, an operation of determining a first combination of partial images including one of a plurality of first candidate images that are candidates for a first partial image and one of a plurality of second candidate images that are candidates for a second partial image; and displaying a second image including the first partial image and the second partial image corresponding to the first combination and disposed along an outline of a first image.

Accordingly, it is possible to receive an operation of determining the first combination of the partial images and display the second image including the first partial image and the second partial image corresponding to the first combination and disposed along the outline of the first image. Therefore, the first partial image and the second partial image in the second image can be selected from the plurality of first candidate images and the plurality of second candidate images, and a degree of freedom of presentation can be increased.

What is claimed is:

1. A display method comprising:
receiving, via a first user interface image, an operation of determining a first combination of partial images including one of a plurality of first candidate images that are candidates for a first partial image and one of a plurality of second candidate images that are candidates for a second partial image; and
displaying a second image including the first partial image and the second partial image corresponding to the first combination and disposed along an outline of a first image.

2. The display method according to claim 1, wherein
the first user interface image includes
an image indicating the first combination including the one of the plurality of first candidate images and the one of the plurality of second candidate images, and
an image indicating a second combination including one of the plurality of first candidate images and one of the plurality of second candidate images, the second combination being different from the image indicating the first combination, and
the operation is an operation of selecting the image indicating the first combination.

3. The display method according to claim 1, wherein
the first user interface image includes an image for receiving an operation of selecting one of the plurality of first candidate images as a candidate for the first partial image and an operation of selecting one of the plurality of second candidate images as a candidate for the second partial image.

4. The display method according to claim 2, wherein
the one of the plurality of first candidate images in the image indicating the first combination and the one of the plurality of first candidate images in the image indicating the second combination have different appearances.

5. The display method according to claim 2, wherein
the one of the plurality of first candidate images in the image indicating the first combination and the one of the plurality of first candidate images in the image indicating the second combination have a same color and a same pattern,
the one of the plurality of second candidate images in the image indicating the first combination and the one of the plurality of second candidate images in the image indicating the second combination have a same color and a same pattern, and
a disposition of the one of the plurality of first candidate images in the image indicating the first combination is different from a disposition of the one of the plurality of first candidate images in the image indicating the second combination.

6. The display method according to claim 1, further comprising:
displaying a second user interface image for selecting any one of a first method and a second method, wherein
when the first method is selected, the first user interface image includes
an image indicating the first combination including the one of the plurality of first candidate images and the one of the plurality of second candidate images, and
an image indicating a second combination including one of the plurality of first candidate images and one of the plurality of second candidate images, the second combination being different from the image indicating the first combination, and
when the second method is selected, the first user interface image includes
an image for receiving an operation of selecting one of the plurality of first candidate images as a candidate for the first partial image and an operation of selecting one of the plurality of second candidate images as a candidate for the second partial image.

7. The display method according to claim 1, further comprising:
receiving, via a third user interface image, an operation of determining a third combination of partial images including one of a plurality of third candidate images that are candidates for a third partial image and one of a plurality of fourth candidate images that are candidates for a fourth partial image, wherein
displaying the second image includes displaying the second image and a third image that includes the third partial image and the fourth partial image corresponding to the third combination and that is disposed along the outline of the first image.

8. The display method according to claim 1, wherein
the first partial image is disposed in a first region of the second image, and
the second partial image is disposed in a second region of the second image that does not overlap the first region.

9. A display device comprising:
an optical device; and
at least one processor programmed to execute operations of
displaying a first user interface image by controlling the optical device,
receiving, via the first user interface image, an operation of determining a first combination of partial including one of a plurality of first candidate images images that are candidates for a first partial image and one of a plurality of second candidate images that are candidates for a second partial image, and
displaying, by controlling the optical device, a second image including the first partial image and the second partial image corresponding to the first combination and disposed along an outline of a first image.

10. A non-transitory computer-readable storage medium storing a program, the program causing a computer to execute operations comprising:
receiving, via a first user interface image, an operation of determining a first combination of partial images including one of a plurality of first candidate images that are candidates for a first partial image and one of a plurality of second candidate images that are candidates for a second partial image; and
displaying a second image including the first partial image and the second partial image corresponding to the first combination and disposed along an outline of a first image.
